(19) United States
(12) Patent Application Publication
(10) Pub. No.: US 2007/0174652 A1
(43) Pub. Date: Jul. 26, 2007

(54) PARTS RECOVERY METHOD AND SYSTEM

(75) Inventor: Alberto Perez Padilla, Martinez, GA (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 11/427,069

(22) Filed: Jun. 28, 2006

Related U.S. Application Data
(63) Continuation of application No. 11/266,416, filed on Nov. 3, 2005, now abandoned.
(60) Provisional application No. 60/624,735, filed on Nov. 3, 2004.

(51) Int. Cl. G06F 11/00

(52) U.S. Cl. 714/1

(57) ABSTRACT

A system and method for tracking parts (components that may include assemblies) used for warranty and repair service, and analyzing the information to determine quality performance of suppliers, vendors, and manufacturers and to recover and invoice the suppliers for warranty service expenses.

### CROSS-REFERENCES TO RELATED APPLICATIONS

This application claims the benefit of U.S. provisional application Ser. No. 60/624,735 filed on Nov. 3, 2004 and incorporated herein by reference.

The disclosure of this patent document contains material, which is subject to copyright protection. The copyright owner has no objection to reproduction by anyone of the patent document or the patent disclosure, as it appears in the Patent and Trademark Office patent file or records, but otherwise reserves all copyright rights whatsoever.

### Field of the Invention

This application relates generally to a system and method for tracking parts. More specifically, this application relates to a system and method for tracking parts used for warranty and repair service, and analyzing the information to determine quality performance of suppliers, vendors, and manufacturers and to recover warranty service expenses.

### BACKGROUND OF THE INVENTION

Manufacturing quality products is an important concern in the competitive marketplace of consumer goods. However, because modern manufacturers often subcontract individual components (parts), which might even include assemblies of other components, it can be difficult to ensure that the final product is of high quality and to track quality problems. It would be advantageous to provide a way to monitor the quality of vendors and subcontractors in a cost-effective manner, and use the results to enforce quality requirements. In this way, consumer expectations of high quality can be better achieved.

Furthermore, warranty work can often cost manufacturers a substantial amount of money. Thus, by ensuring high-quality components and component assemblies, manufacturers can reduce costs. Warranty repair work is a potential source of information about the quality of components and assemblies obtained from vendors and subcontractors. It would be advantageous to have a way to assess vendor and subcontractor quality performance from warranty work histories. A way to recover costs related to failed components would also be useful.

Still further, because complex consumer products often have many components and assemblies that may need to be replaced or repaired, it can be difficult to ensure that proper numbers of these parts are available for warranty and other repair services, and that vendors and subcontractors are timely notified of requirements to stock up inventories of such parts, and that repair centers can obtain information about such parts and easily order parts as needed. Thus, needed is a system and method that supports these needs in a timely, cost effective, and advantageous manner.

### SUMMARY OF THE INVENTION

Provided is method for quality improvement and cost recovery using a tracking system, the method comprising the steps of:
determining which components failed in a plurality of a particular product;
the system automatically calculating recovery costs for the failed components;
the system automatically determining which among a plurality of suppliers provided the failed components;
the system automatically allocating the recovery costs among the plurality of suppliers according to which suppliers provided the failed components;
the system automatically generating quality information for the plurality of suppliers which provided the failed components; and
the system automatically providing an appropriate portion of the quality information to one or more of the plurality of suppliers, which provided the failed components.

Also provided is a method for quality improvement and cost recovery using a tracking system including a database, the method comprising the steps of:
providing a plurality of components, each of the components being associated, in the database, with a supplier who produced the component;
providing a plurality of products each including at least one of the components;
determining which of the components failed during a warranty period of each of the products;
creating a record of each of the failed components in the database;
collecting some number of the components that failed for analyzing the some number of failed components;
creating a record of each of the some number of failed components in the database;
determining corresponding failure information for each of the some number of failed components;
associating, in the database, the record of each of the some number of failed components with the corresponding failure information;
the system automatically calculating a recovery cost for each of the suppliers based on the total number of failed components provided by the each of the suppliers;
storing the recovery costs in the database;
the system automatically generating an electronic invoice based on the recovery cost for each of the suppliers;
the system automatically generating a quality report for each of the suppliers, the quality report including information about the failed components provided by the supplier and also including information about the associated failure information;
the system automatically providing each of the invoices to the appropriate one of the suppliers; and
the system automatically providing each of the quality reports to the appropriate one of the suppliers.

Further provided is a method for quality improvement and cost recovery using a tracking system connected to the Internet, the system including a database and a server, the method comprising the steps of:
providing a plurality of a product, the product including at least one of a plurality of components provided by a supplier;
entering a record of each of the components in the database;
associating, in the database, the supplier with the component records;
determining which of the components failed in the plurality of products during a warranty period of each of the products;
creating a record of each of the failed components in the database;
calculating a statistically appropriate sample size of the failed components when the failed components fail at a higher than expected rate during the warranty periods;
shipping a specific number, based on the sample size, of the failed components to the supplier;
creating a record of each of the shipped components in the database;
tracking the shipped components using the system;
the supplier analyzing the shipped components to determine failure information about each of the shipped components;
the supplier using the system to enter, via the internet, the failure information into the database;
associating, in the database, the record of the shipped components with the corresponding failure information;
the system automatically calculating a recovery cost for the supplier based on at least all of a total number of the number of failed components, the cost of the failed components, and a labor cost of repairing the products including failed components;
storing the recovery cost in the database;
the system automatically generating an electronic invoice, based on the recovery cost, for the supplier;
the server automatically sending, via a communication network, the electronic invoice to the supplier;
the system automatically generating a quality report for the supplier, the report utilizing the failure information and at least some of the records stored in the database; and
the system server automatically providing the supplier secures access to the quality report via a computer connected to the communication network.

And further provided is the system for implementing one or more of the above methods, wherein the system includes a server and a database. The system may be connected to a communication network, such as the internet, for example, to allow for remote access to the system by users possibly including suppliers.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a top-level system diagram showing how the system interacts with various external entities;

FIG. 1A is a high-level diagram showing the major components for implementing one embodiment of the invention;

FIG. 1B is a flow chart showing the top-level functional steps of the method of one embodiment of the invention;

FIGS. 2 and 3 are top-level flow charts showing an overview of the system process of one embodiment of the invention;

FIG. 4 is a high-level flow map for the system process showing the overall functional flow of the process broken down into 9 steps in the order typically utilized by a user for the embodiment of FIGS. 1 and 3.

The screen shots of FIGS. 5 through 21 are of an example embodiment and are protected by copyright. All rights are reserved by the copyright holder, subject to the caveat provided in the first paragraph of this specification.

FIG. 5 shows a screen shot of the example embodiment of a welcome screen for the system to start the process;

FIG. 6 shows a screen shot of the example embodiment of a screen supporting a second step of the process providing information about the chosen parts;

FIG. 7 shows a screen shot of the example embodiment of a screen supporting step 3 and providing detailed information about the parts movement;

FIG. 8 shows a screen shot of the example embodiment of a screen supporting step 4, which provides information about numbers of parts that have been sold;

FIG. 9 shows a screen shot of the example embodiment of a screen supporting step 5, showing information about the servicer that replaced a part;

FIG. 10 shows a screen shot of the example embodiment of an input screen for adding/updating the information of step 4;

FIG. 11 shows a screen shot of the example embodiment of a screen supporting step 6 of the process for providing information on returned parts from one of the servicers of step 5;

FIG. 12 shows a screen shot of the example embodiment of a screen for inputting information (e.g., parts received dates) for step 6;

FIG. 13 shows a screen shot of the example embodiment of a screen supporting step 7 of the process. The screen determines the numbers of parts returned to a supplier, and which plants/servicers returned them.

FIG. 14 shows a screen shot of the example embodiment of a screen for inputting information for step 7;

FIG. 15 shows a screen shot of the example embodiment of a screen supporting step 8 of the process. It shows the parts received by a supplier;

FIG. 16 shows a screen shot of the example embodiment of a screen for inputting information for step 8;

FIG. 17 shows a screen shot of the example embodiment of a screen supporting step 9 of the process, showing the determined causes of failures, and the corrective action to repair the part, for example;

FIG. 18 shows a screen shot of the example embodiment of an input screen for entering information for step 9;

FIG. 19 shows a screen shot of the example embodiment of an example screen of the various options that will be available for managing this process;

FIG. 20 shows a screen shot of the example embodiment of an example screen for allowing the manufacturer to add a Vendor who is to be invoiced and to identify parts associated with that vendor and for management of this information;

FIG. 21 shows a screen shot of the example embodiment of a screen providing the ability to allow the manufacturer to find existing vendors and to manage them;

FIG. 22 shows a screen shot of the example embodiment of a Record Payment screen;

FIG. 23 shows a screen shot of the example embodiment of a Parts Vendor Main Menu; and

FIG. 24 is a spreadsheet showing some fields for a parts return strawman in the example embodiment.

### DETAILED DESCRIPTION OF THE PREFERRED EMBODIMENTS

Provided is a system and method for augmenting the parts return process for a manufacturer to ensure accurate invoicing to suppliers. As parts are returned from the field due to warranty or other repair work, it is necessary to track the part by, for example, SKU at the individual part level, giving internal employees and suppliers the ability to access the information regardless of their location.

The system and method described below can be used to identify the initial warranty expense. If there is a part associated with the initial warranty service call, the part is identified. A prepaid label to return the replaced part to the correct manufacturing facility is sent to the Servicer. The part is returned and tracked to share information. Engineering and Quality (at both the Manufacturer of the finish product and the component test the part to determine the root cause of the failure. Initiatives generate correction actions at all levels of the process chain (from the Servicer on the initial call to the Supplier of the component part to the manufacturer prescribing the application of the component). Any parts returned to and determined to have no apparent defect are also addressed. The end result is a continued reduction of failures in the field, and improved product quality to the end consumer.

Traditionally, the data is collected at the plant level in spreadsheets, which are not accessible outside of each plant for both internal and external interested parties. The System and method provide part level tracking that allows authorized users to access a problem part in simple screens in a useful style. Whenever possible, much of the initial information from a service claim will be tied to the return part, based on input into the system by servicers. The system will make key information such as part status, location and resolution available to all appropriate users. The percentage of parts returned that prove to be truly at fault will be rolled into reporting within the existing parts recovery application for invoicing.

The information provided by the system can then be used to evaluate vendors/suppliers, improve product (and part) quality, recover warranty costs, and many other beneficial uses.

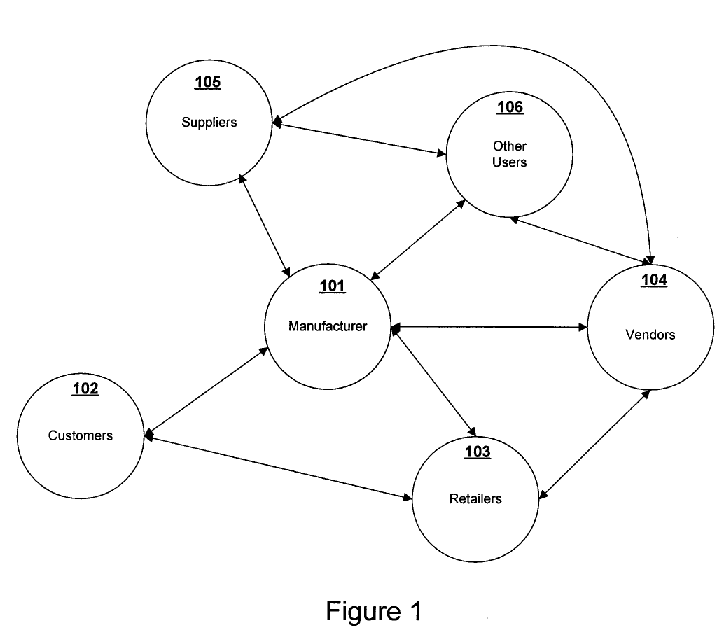

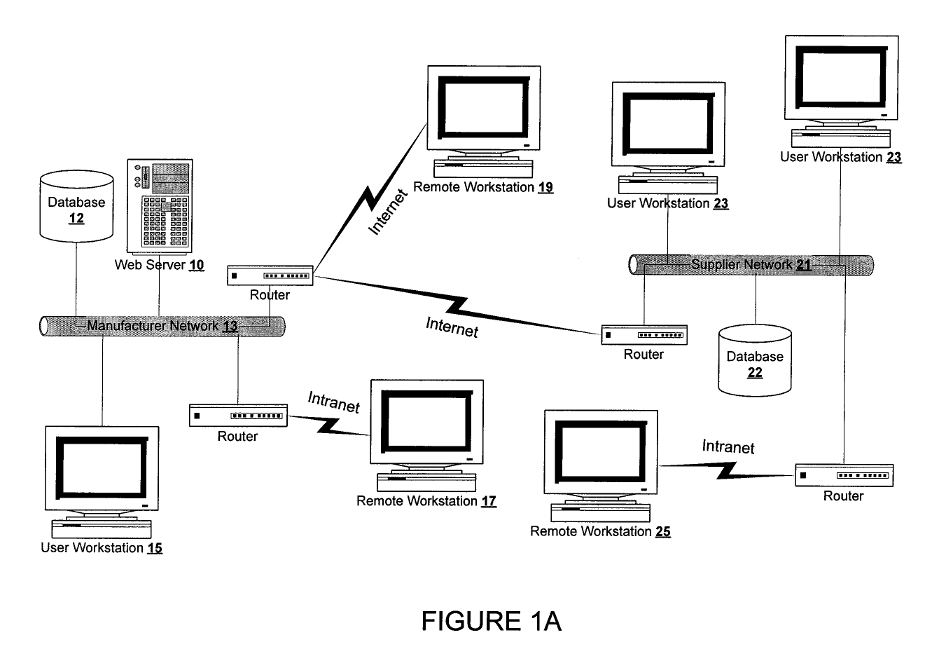

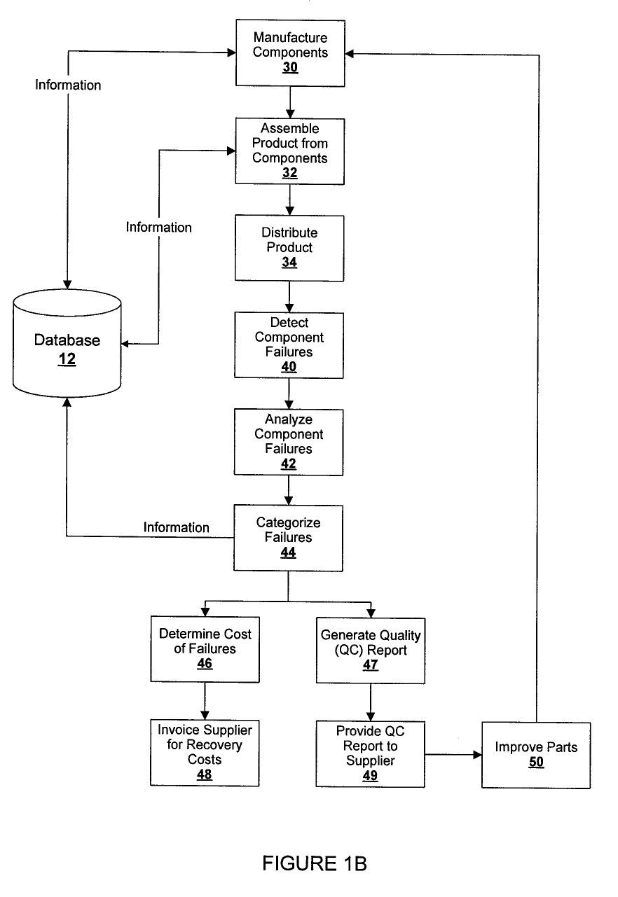

FIG. 1 is a top-level system diagram showing how the various parts of the overall system interact with each other. The system provides a way for the manufacturer 101 to standardize the warranty recovery process, communicate warranty recovery expectations to the supplier base (suppliers 105, vendors 104, and others 106) generate notifications on component part failures within the first year of a product's life cycle, monitor and track failures and drive improvements by, for example:
Collecting information about parts replacement;
Identifying Parts Failures During a Warranty period;
Supporting Parts Warranties; and
Invoicing and Managing Process for Recovery of Warranty Costs from Parts Vendors.
   The suppliers 105 could provide one or more components used for producing a product directly to the manufacturer 101 who manufactures the product, or to a third party vendor 104, for example, who then might provide the manufacturer 101 with the components. There may be other participants 106, and these various parties may switch roles in a variety of manners. The manufacturer 101 then might sell the product directly to the consumer 101, or to the customers via retailers 103.

The monikers given the individual participants are not important. The key to the relationships is that a manufacturer of a product obtains components used in that product from one or more other parties, and the manufacturer needs to track failures in those components and trace the component back to the ultimate producer, and or intermediate users, of that product. Thus, an assembly may be traced back to an assembler, but the assembler may obtain parts from various suppliers. It would be useful to trace all of these parts and the assembly back to their originators.

For ease of description, the terms “vendor”and “supplier” may be used interchangeably herein, even though these functions may (or may not) be separated in actual practice. Likewise, the terms “parts” and “components” are used interchangeably. The proposed system is capable of supporting either any of these, and additional, scenarios.

For components (parts) that are manufactured internally, a fictitious “virtual” vendor can be established, and then the system/method of the invention used to track failures of these components, and thus internally manufactured parts can also be evaluated.

The system provides the ability to perform claims processing functionality, which can be provided to support warranties, to help reduce the overall product claim costs, and allow for better accounting of actual expenses. For example, the system can periodically automatically generate and send invoices to specified parts suppliers for cost recovery due to part failures within a first period (e.g., first year) of the product warranty. The system could identify part failures on claims processed in the billing cycles completed during the previous month, for example. Vendor Invoices can be generated based upon this data and sent to the Vendor, for example, or can be sent to customer-identified personnel such as Plant GMs, Purchasing Directors, the buyer and AR personnel.

The system could utilize the most modern computer and networking capabilities to allow distributed access to this information wherever various parties are found.

FIG. 1A shows a possible hardware approach to implementing the invention, including that used for the Example Embodiment given below.

Typically, the manufacturer implementing the system will utilize a server, such as a Web Server 10, to provide and format information stored in a Database 12 to the various parties via a local Network 13, including local system users on a Workstation 15, and remote system users. The server, or another server, could be utilized to receive information from the various connected workstations. Remote users can be connected via an intranet, such as Remote Workstation 17, or via the Internet such as Remote Workstation 19. Furthermore, other parties can also be connected to the server via the internet, and can utilize their own network, such as the Supplier Network 21, as shown. As an example, Supplier Network 21 can connect to additional User Workstations 23, or additional Remote Workstations 25. The Supplier Network may also have its own Database 22 to locally store information provided by the system.

FIG. 1B is a flow chart showing the top-level functional steps of the method of one embodiment the invention, such as the Example Embodiment discussed below.

Typically, suppliers will manufacture components 30 for assembly into a product 32 by the manufacturer. The manufacturer, or a retailer, will distribute the product 34 to customers.

As customers use the product, some will inevitably fail. The system can detect the failures of the various components 40 by monitoring repair centers, for example, by requiring a reporting of replacement components provided to repair the product, or by internal monitoring if the manufacturer performs the repairs. At least some portion of the failed components is analyzed 42 to determine why the components failed. The failed components are categorized into the types of failures 44, and the sources of the failures are attempted to be determined.

The cost of the failures is determined 46, and the supplier of the failed component(s) can be invoiced for the recovery costs 48. Also, a quality report can be generated 47, and provided to the supplier 49, to implement a process improvement program 50 to improve component quality.

Information from various points of this process is stored in the database 12 for use in generating the various outputs and for maintaining a failure history.

Note that the sequence of the above steps might be changed; different data and/or reports generated, collected, and/or stored; and/or different parties perform the various steps; without straying from the overall concept of the invention.

The process of the invention may be implemented in a manner that one skilled in the art of computer programming and web-based design and programming would understand. Various programming tools, including one or more of Java, Java script, various versions of C, various web development tools such as Shockwave or similar tools, scripting or compiled software, etc. could be utilized, as desired. Custom or off-the-shelf servers, compilers, etc. could be utilized along with commercially available computers, such as PC compatible Windows, Macintosh, Linux, or Unix based machines.

Typically, it would be desirable that workstations utilized commercially available web browsers to utilize the system of the invention, but custom programs could be loaded to provide enhanced functionality. Furthermore, it may be desirable to provide security measures as in known in the art to prevent unauthorized use or adulteration of the data.

### EXAMPLE EMBODIMENT

The Example Embodiment discussed in this section utilized a Web page based implementation and the Internet, such as shown in FIG. 1A, to implement the process of the invention, such as that shown in FIG. 1B.

The following table gives a basic flow for the processing according to one embodiment. Variations of course will occur for particular implementations:

TABLE 1

| Time | Manufacturer | System | Vendor |
|---|---|---|---|
| Initial Setup | Creates Vendor and | Stores appropriate | Is Notified of Accounts and access |
| | creates initial values | information. | to System. |
| | for Terms and Parts. | | |
| During the Month | Add/Delete parts as | Processes Claims As | Receive parts as processed through |
| | corrective actions | Normal | the system |
| | generate results. | | |
| Month Ends | Calculates and | Summary information | Receives Invoice |
| | updates the parts in | is gathered by | |
| | use data. | Vendor. Invoices are | |
| | | created and | |
| | | distributed. | |
| During the Month | Reviews Vendor's | Processes Claim As | Uses system to review problems. |
| | Performance and | Normal for the Next | Makes payment. |
| | enters Debits & | Month. | |
| | Credits | | |

For components (parts) that are manufactured internally by the manufacturer intending to implement the invention, a fictitious “virtual” vendor can be established. This virtual vendor can be assigned components as in other vendors but will be designated to not receive an Invoice. In this manner, internally manufactured parts can also be evaluated.

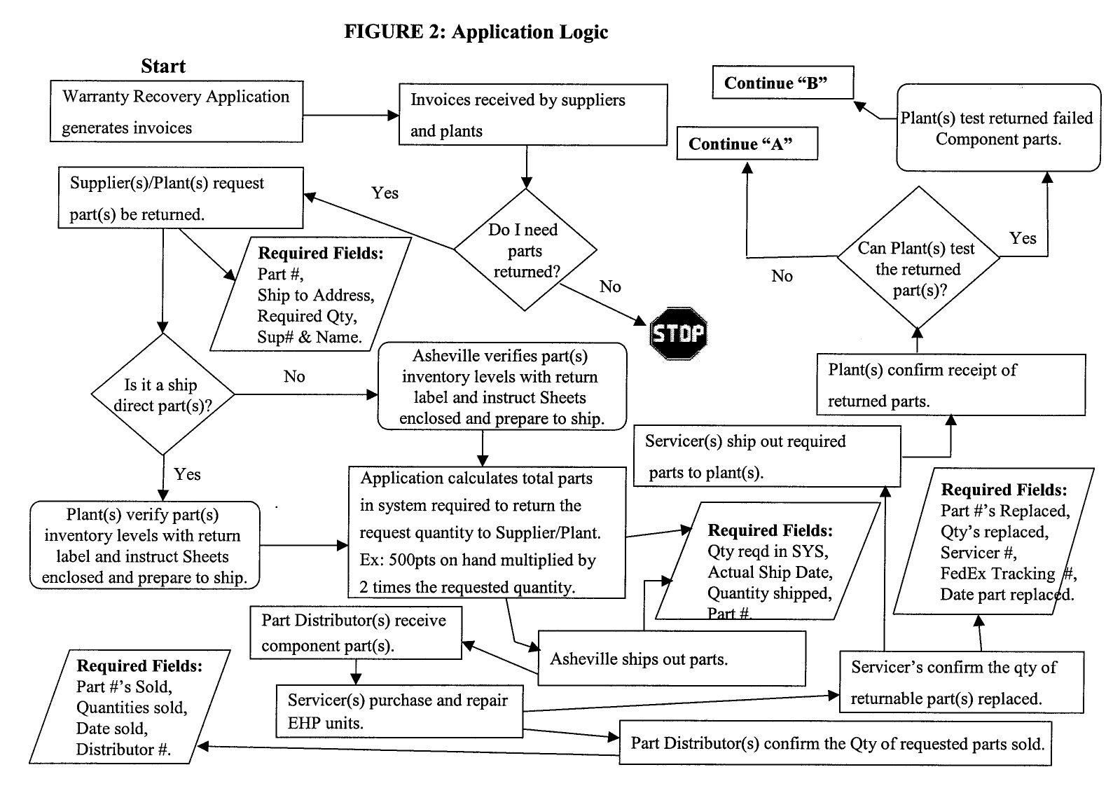

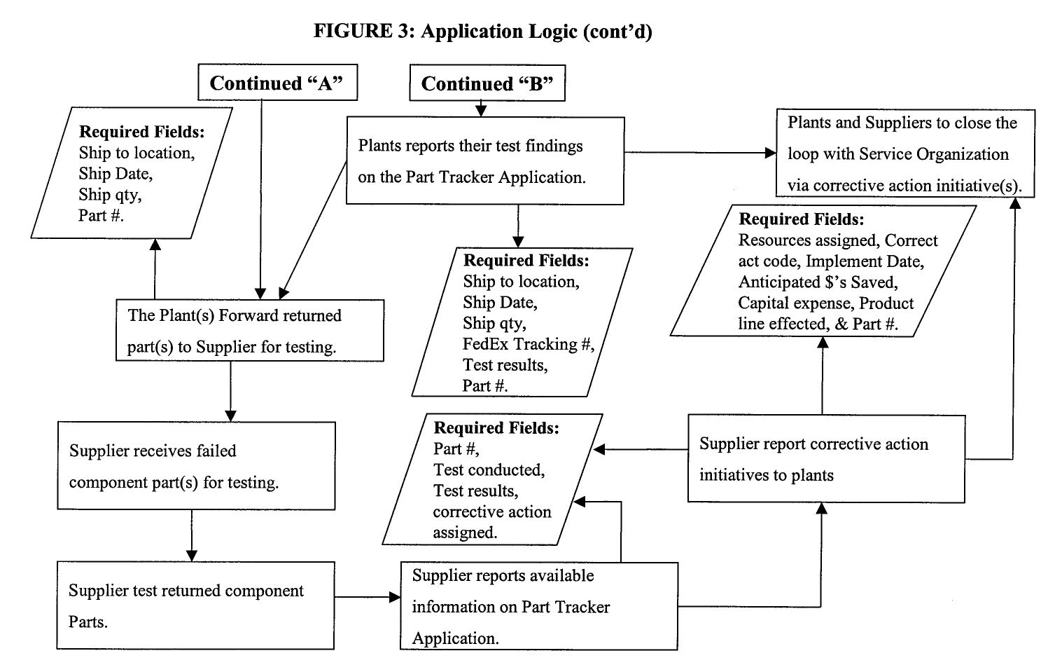

FIGS. 2 and 3 are top-level flow charts showing a general overview of the system process for the example embodiment. Below, the system operation and data entry screens of the example embodiment are described in more detail using an operational perspective.

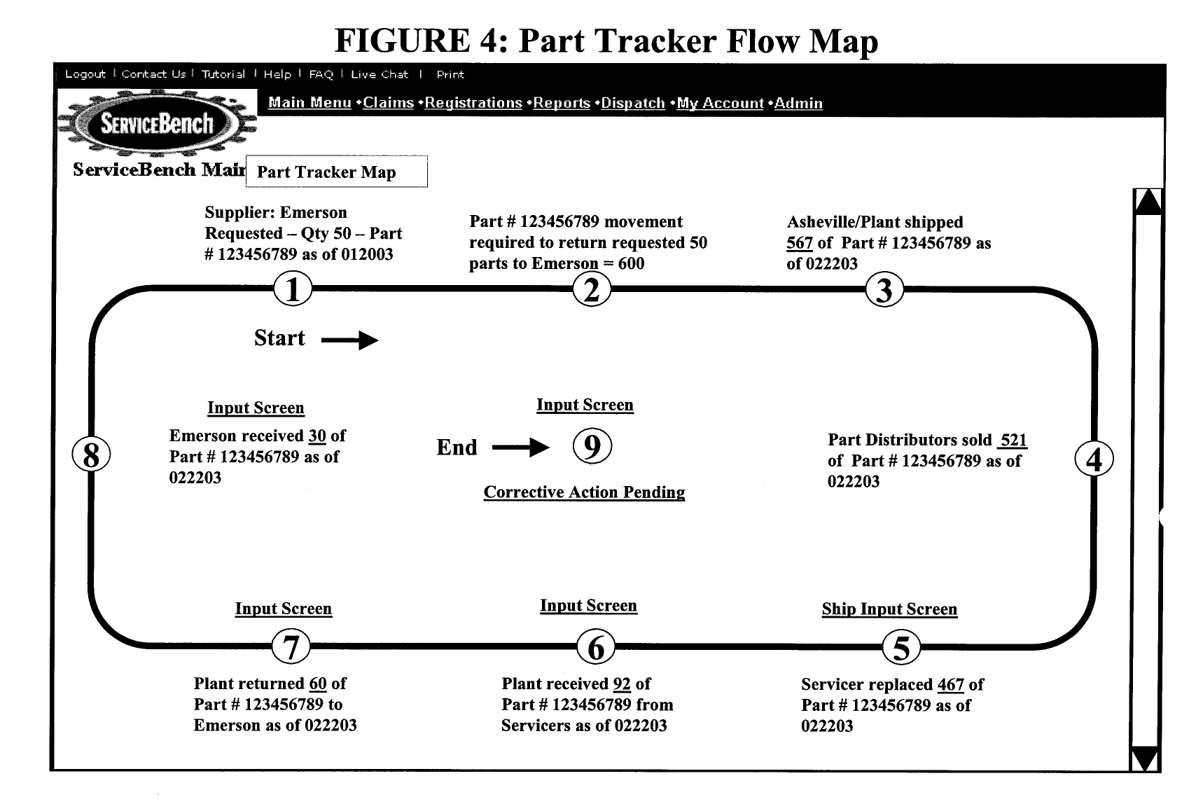

FIG. 4 is a high-level flow map for the system process showing the overall functional flow of the process broken down into 9 steps in the order typically utilized by a user.

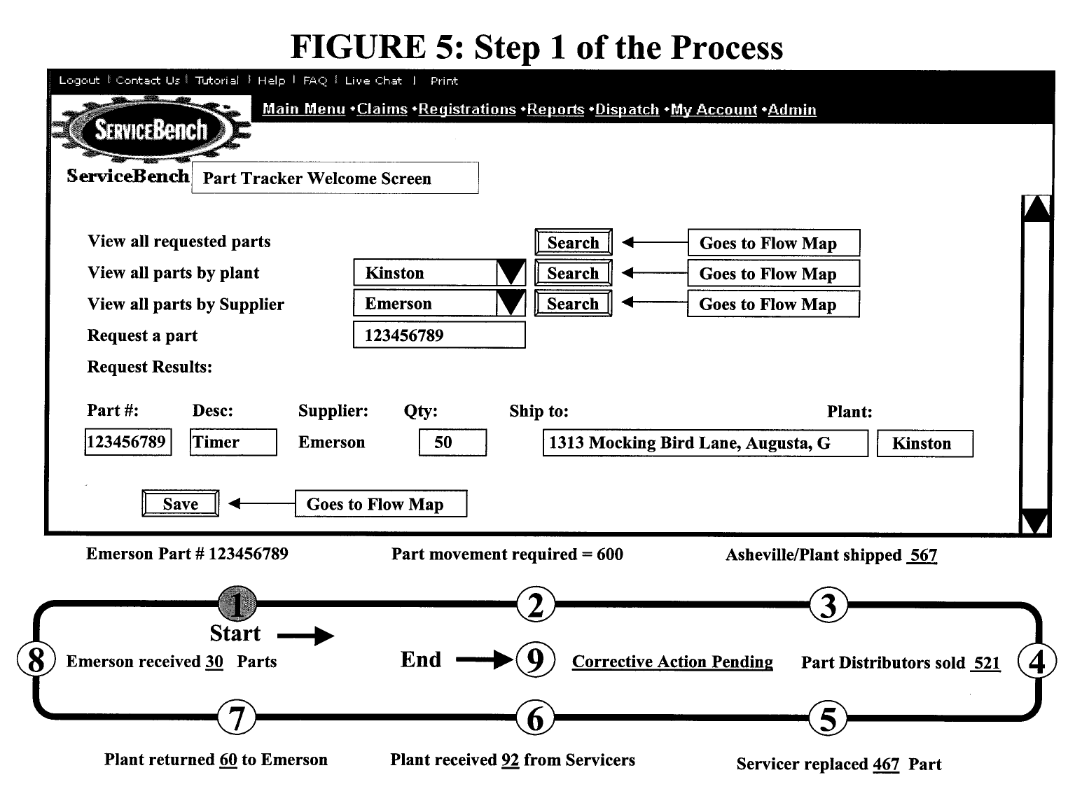

FIG. 5 shows a welcome screen for the system to start the process. This screen provides the user interface to perform vendor and plant searches and allows a user to begin tracking a class of parts (via a part number, for example). The process starts at step 1 with a supplier or plant requiring a part to be returned, and searching for that part using the system, starting at the welcome screen.

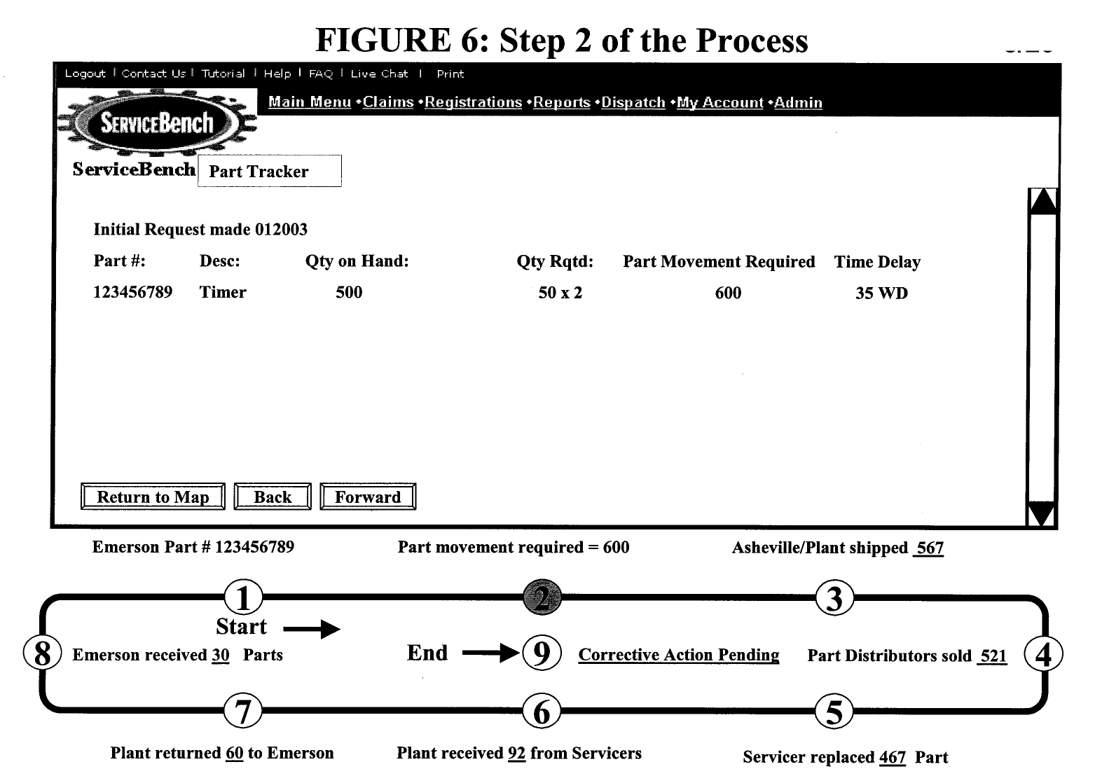

FIG. 6 shows a screen supporting a second step of the process providing information about the chosen parts, in particular to track part movement information.

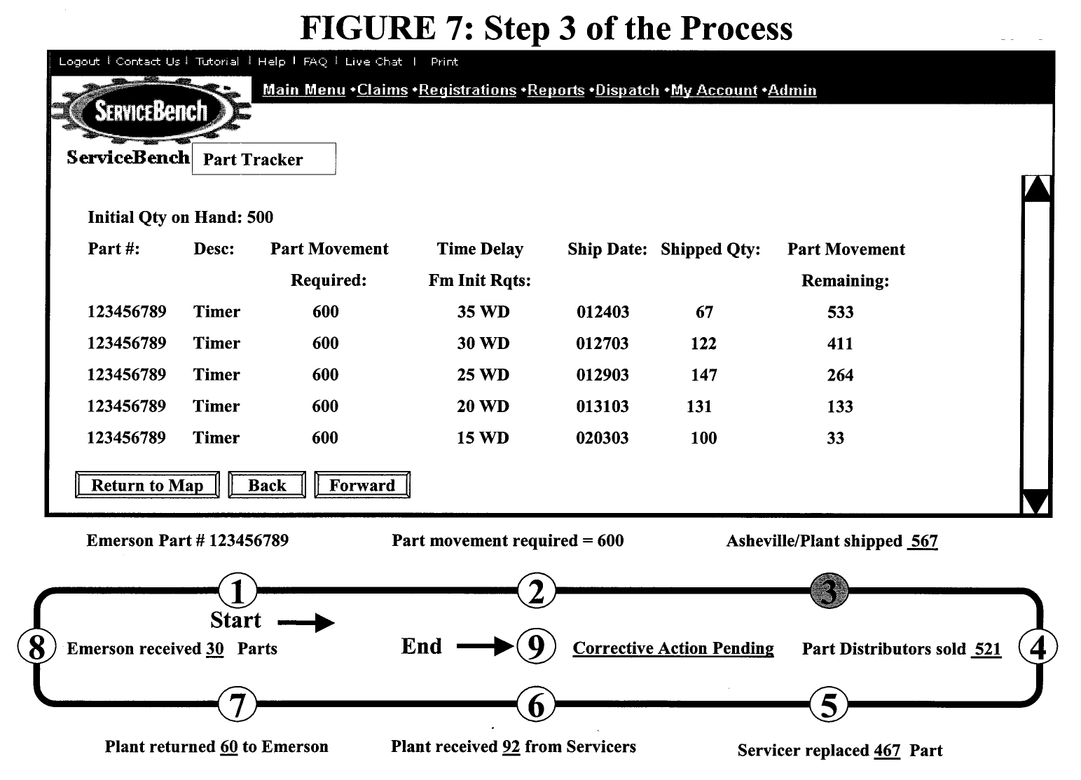

FIG. 7 shows a screen supporting step 3 and providing detailed information about the parts movement, including shipped quantities and remaining to ship quantities, among other information.

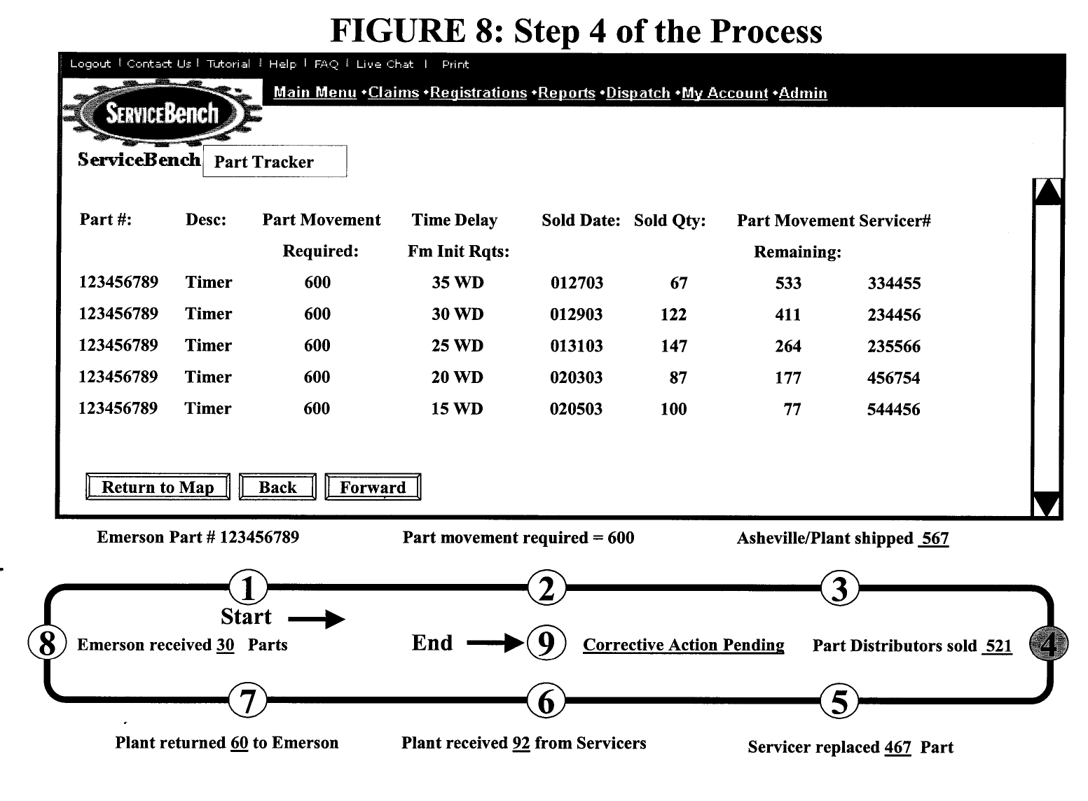

FIG. 8 shows a screen supporting step 4, which provides information about numbers of parts that have been sold.

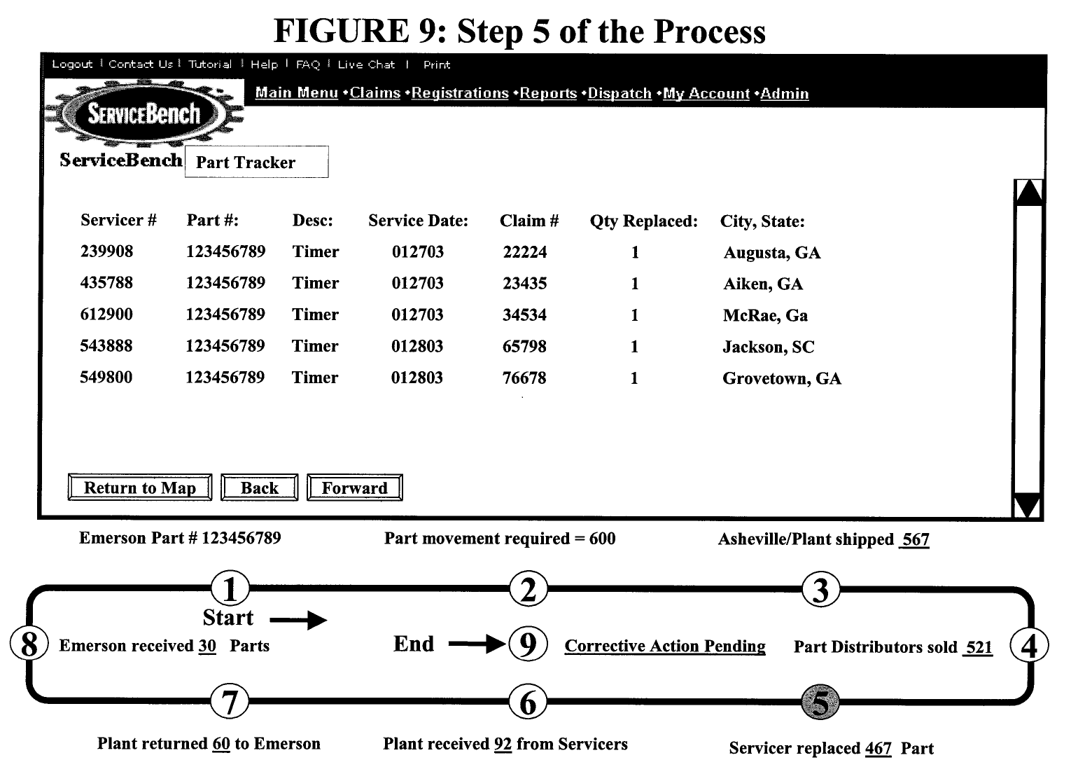

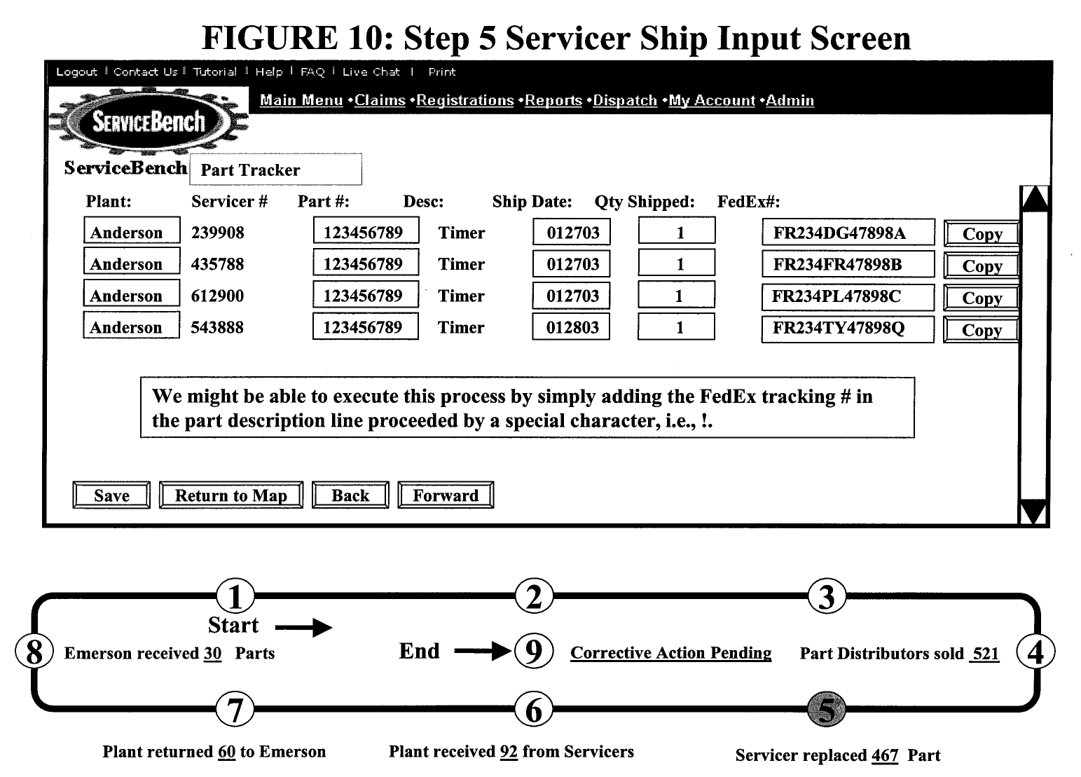

FIG. 9 shows a screen supporting step 5, showing information about the servicer that replaced a part. FIG. 10 shows an input screen for adding/updating this information.

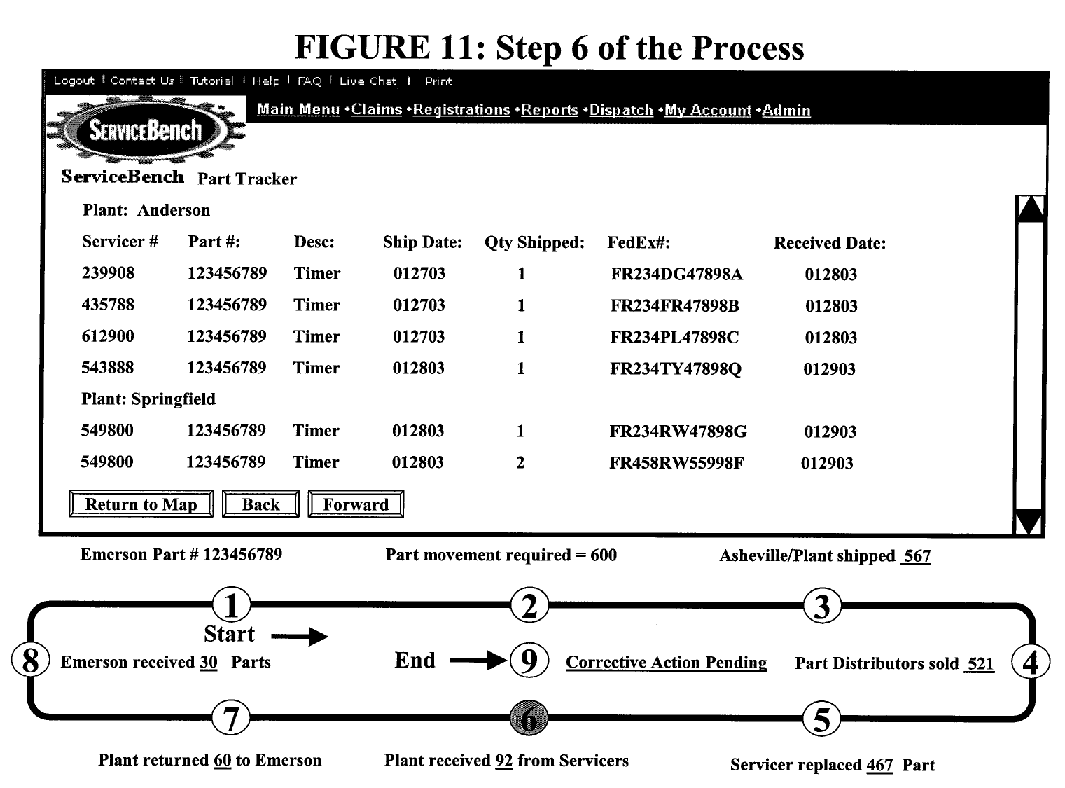

FIG. 11 shows a screen supporting step 6 of the process. The screen provides information on returned parts from one of the servicers of step 5.

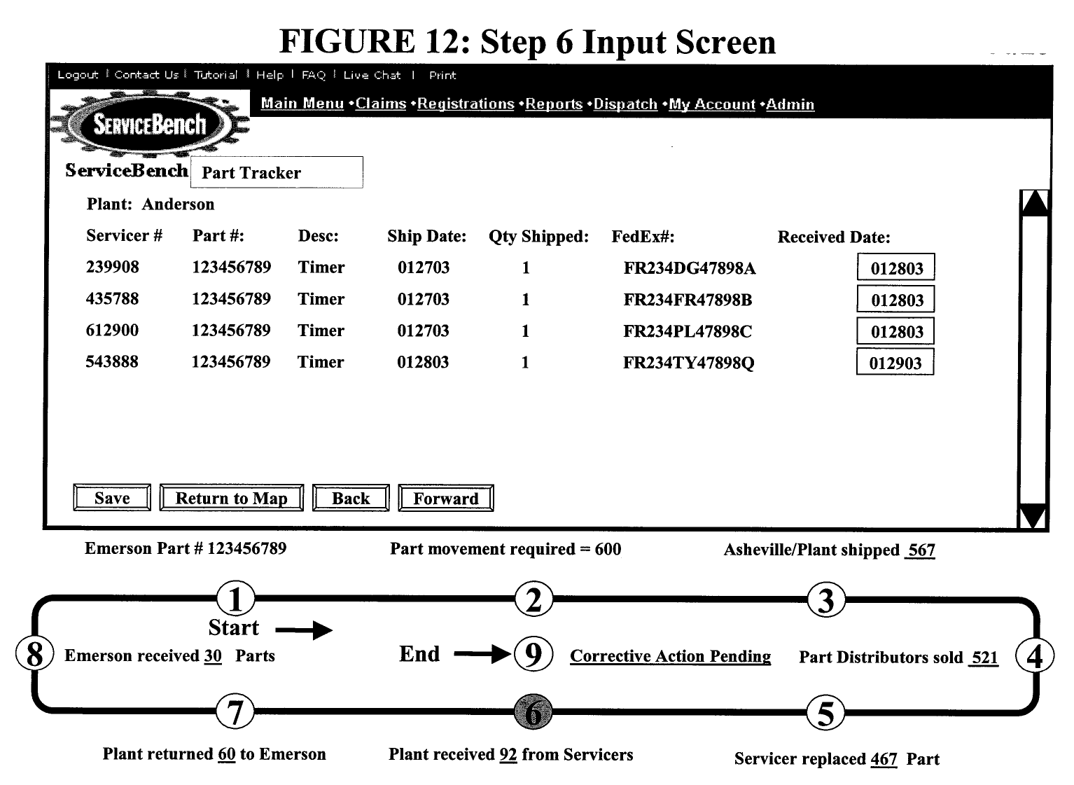

FIG. 12 shows the screen for inputting information (e.g., parts received dates) for supporting this step.

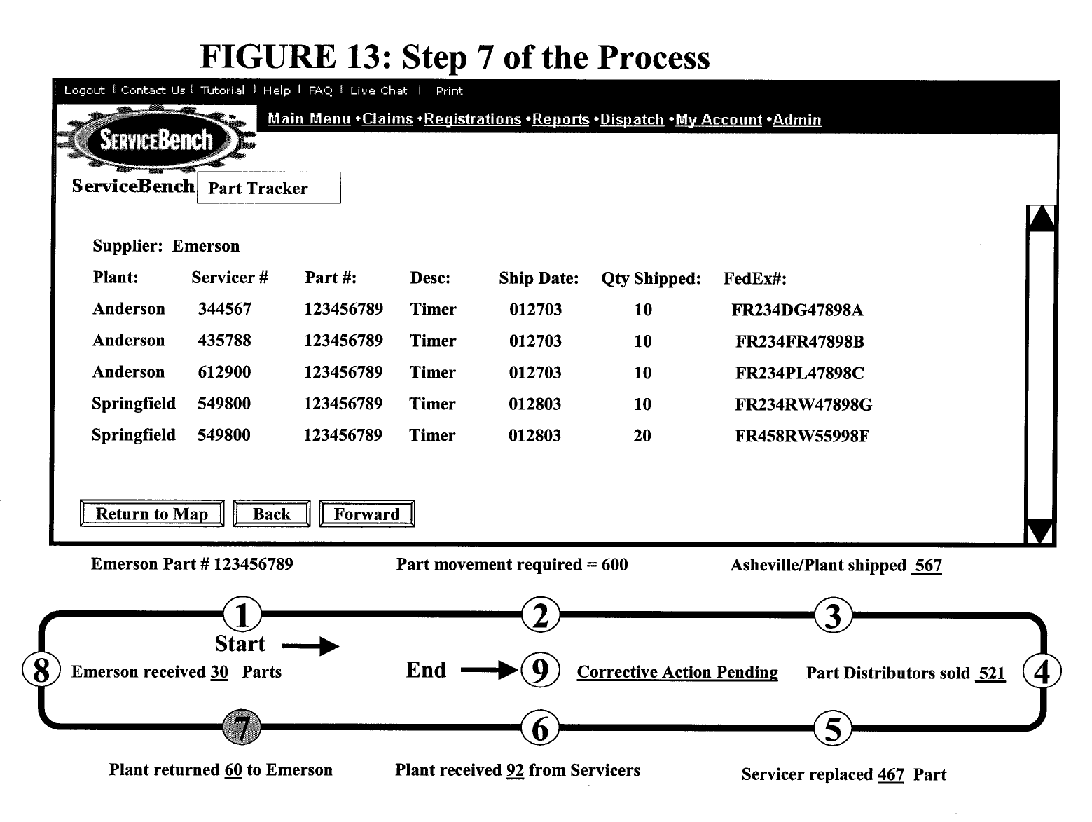

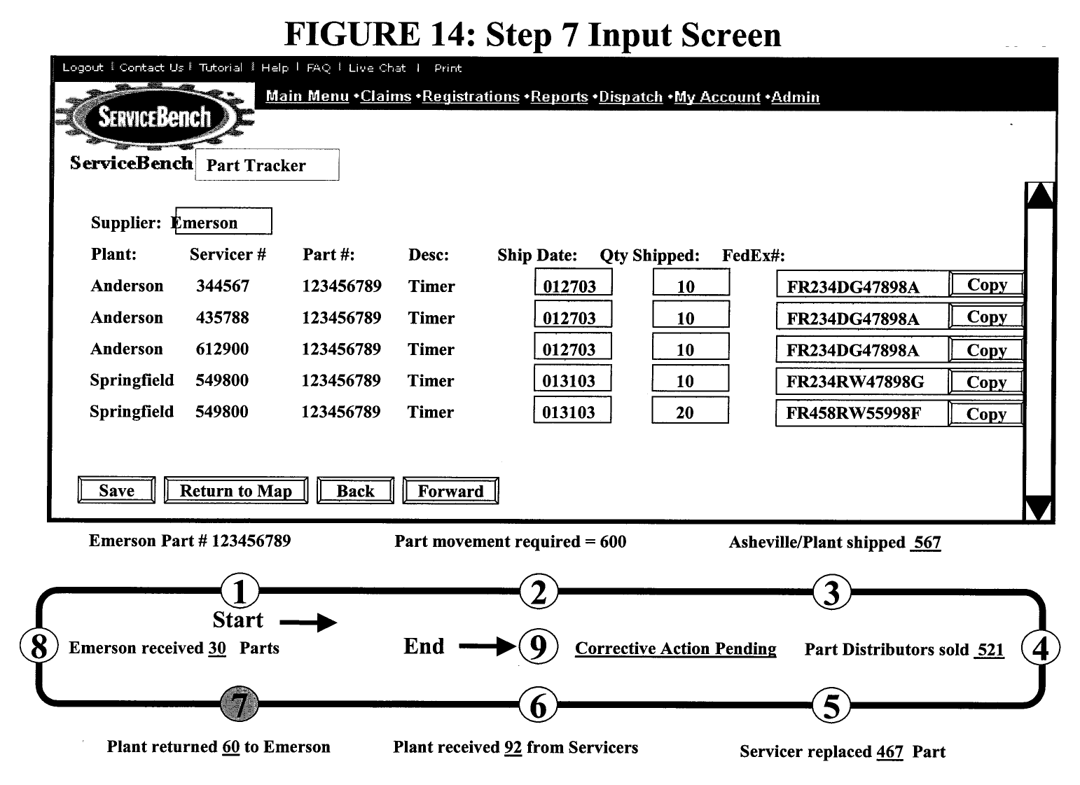

FIG. 13 shows a screen supporting step 7 of the process. The screen determines the numbers of parts returned to a supplier, and which plants/servicers returned them. FIG. 14 shows the screen for inputting this information.

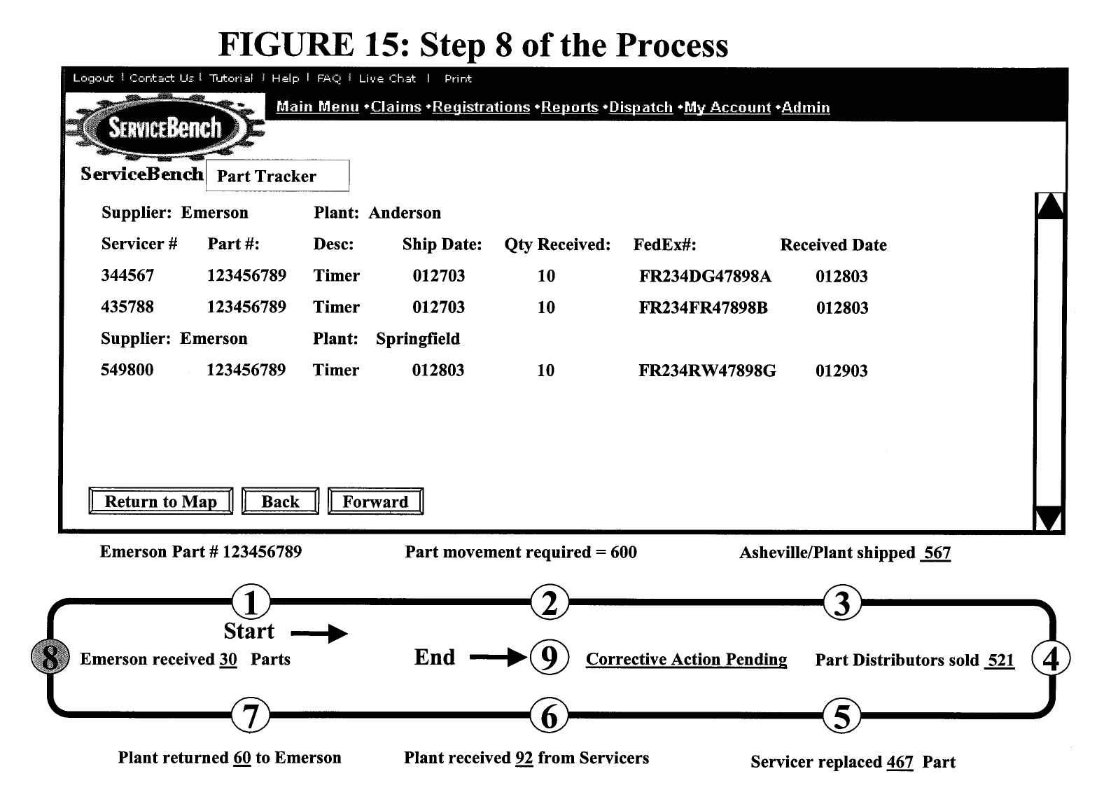

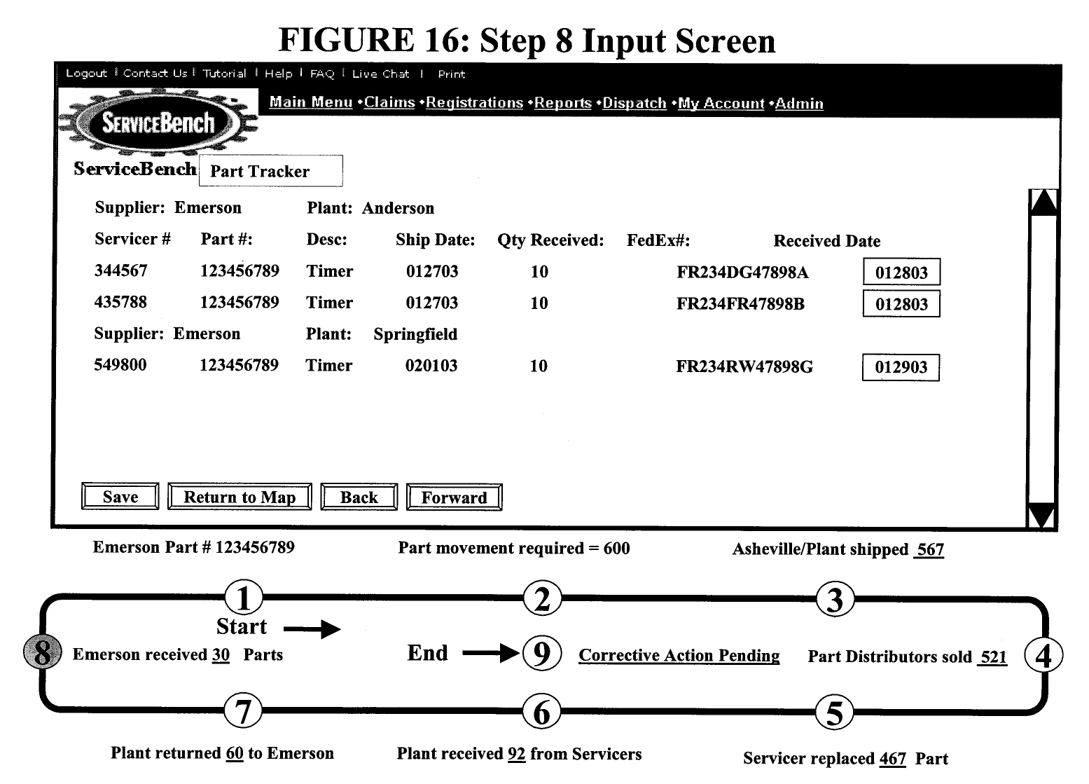

FIG. 15 shows a screen supporting step 8 of the process. It shows the parts received by a supplier. FIG. 16 shows the screen for inputting this information.

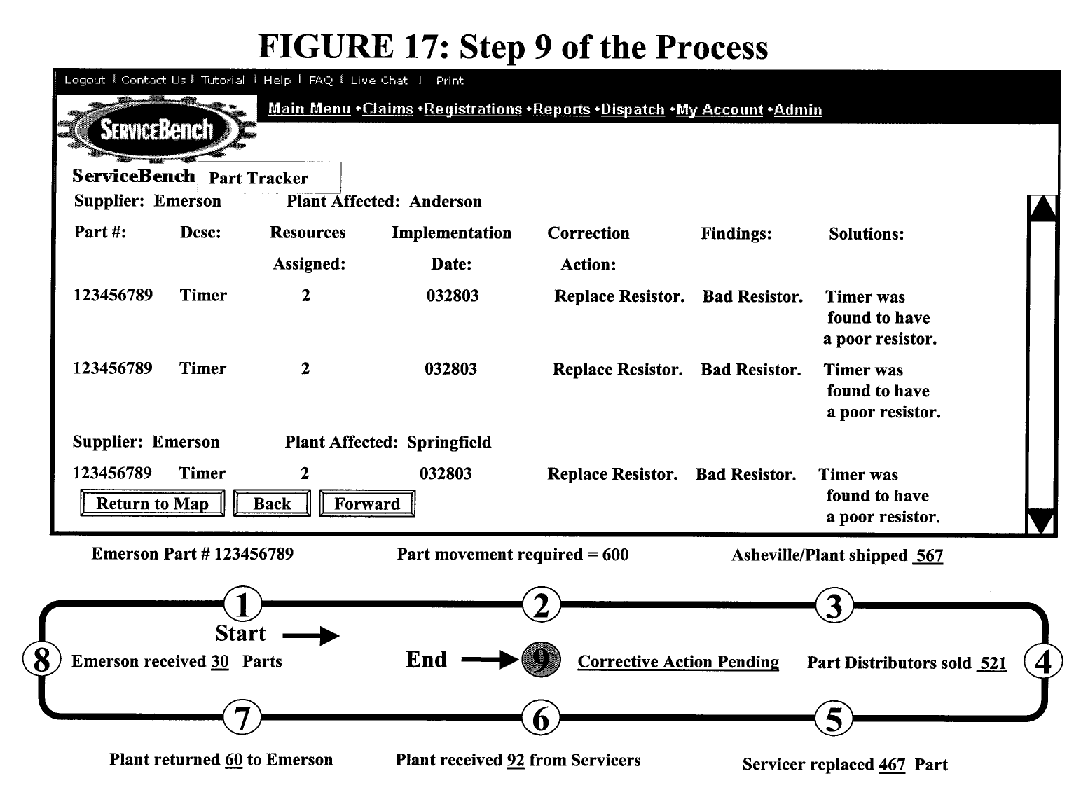

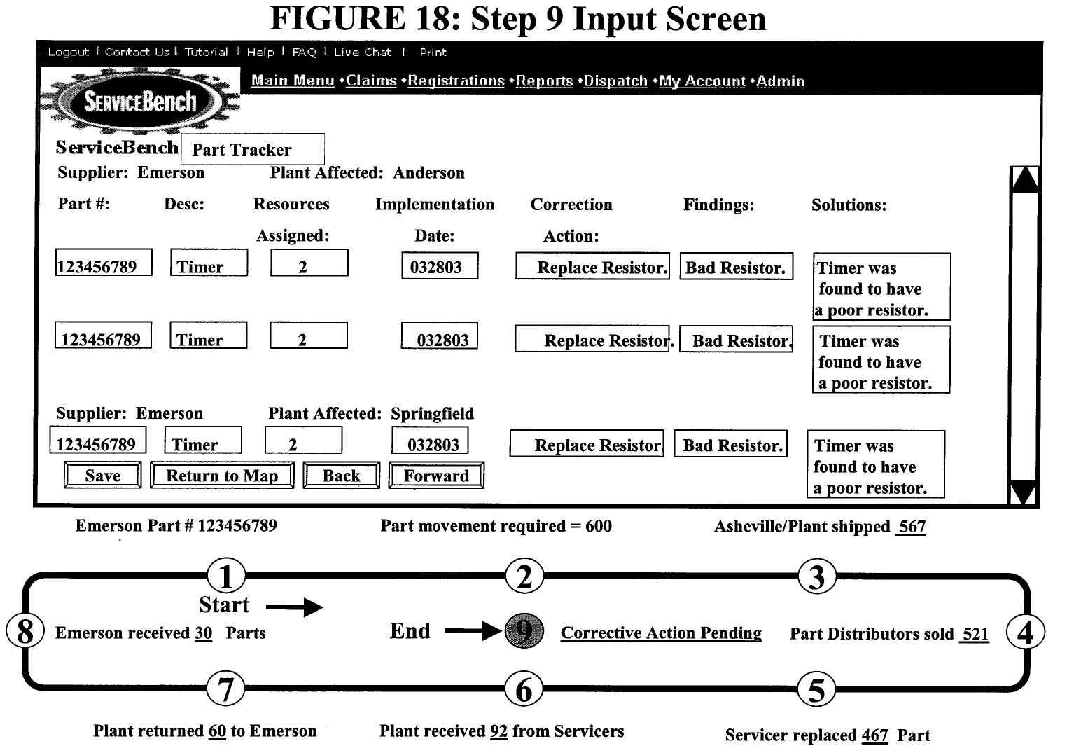

FIG. 17 shows a screen supporting step 9 of the process, showing the determined causes of failures, and the corrective action to repair the part, for example. FIG. 18 shows the input screen for entering the information for this step.

Below is a discussion of how the system/process can help to support the quality control and repair process for a manufacturer.

Part Warranties: Claims processing functionality is provided to support Part Warranties and to make separate checks for this. This can help reduce the overall Product Claim costs and allow for better accounting of actual expenses.

Basic Functionality: On a periodic (e.g., monthly) basis, the system can automatically generate and send invoices to specified Parts Vendors for cost recovery due to part failures within a first period (e.g., first year) of the product warranty. The steps for this can be as follows:
On a periodic basis the system will identify part failures on claims processed in the billing cycles completed during the previous month.
Vendor Invoices will be generated based upon this data and sent:
   Electronically to Vendor;
   Electronically to customer identified personnel such as Plant GMs, Purchasing Directors, the buyer and AR personnel.

The Invoices can be per vendor and the invoice amount will be a function of part cost as well as Labor and other charges associated with specific warranty claims.

The invoice processing will work in a similar manner to the current payment processing for claims. At the end of the month, the system can calculate invoices for Vendors based upon claims that were processed in completed billing cycles within that month. All database updates can record the user responsible for the change and the date when the change was made.

Upon implementation of the system, the manufacture can be better able to handle the process flow and tracking of parts through the process outlined above and below.

Functionality for the Parts Return Flow: When a supplier part fails at a greater percentage than the expected failure rate, the supplier may elect to request a sample of parts to be tested. The supplier will use the System to request a specific part number. The System then calculates a statistically appropriate sample size and provides a system report (in spreadsheet form, for example) that will identify the specific number of parts should be “kitted” for shipment to distributors. This report can be readily forwarded to appropriate staff.

As servicers install these parts in the field, the return packaged part (which is likely a failed part) can contain a shipping label and shipping instructions for return of the part to, for example, the appropriate manufacturer plant, where the part can evaluated for the cause(s) of the failure(s).

When a servicing company, for example, files a claim, the System can prompt the company to return the part (such as via screen popup, for example), print a “Packing List” and then enter the shipping tracking number from the prepaid label so that the failed part can be returned.

Next, the part is received at the plant from shipping courier. The package may contain a packing list or arrive without any additional information inserted.

To begin processing the part, the user can click on a browser link using a System interface (such as a computer terminal), then click on a link for Parts Recovery under a Special Operations function, for example.

Next the user can click on a new link: PartTracker and a search screen will appear. The receiving person in the plant can search for the part in the system by entering the shipping tracking number or any other relevant number that arrives with the part, such as claim number or serial number. If the related part and claim are not found by any available number, the receiving person can have the ability to move forward with the process by initiating a system generated or pre-printed bar code label tracking number.

If the part is successfully located by the System, the user can check a box indicating that the part is received. Once a part has been checked in the System as received, the part tracking process can begin.

From the time the part is received, the user(s) can return to the same data entry screen, which can reflect information spreadsheets, for example. Results and status continue to be updated in the System through completion of the part testing/fault analysis, up to and including the supplier stage of the process. Once findings are complete, the manufacturer can access and use the information to:
Develop/identify corrective actions and timelines;
If no apparent defect, use the information for service community education:
   Final conclusion from testing process is updated in the System by quality.
   Quality or other designated personnel apply a percentage of the invoice for the part in Parts Recovery—Manage Parts function in the System based on negotiated rate.
   Projected Cost Savings as a result of quality improvements can be documented and tracked.

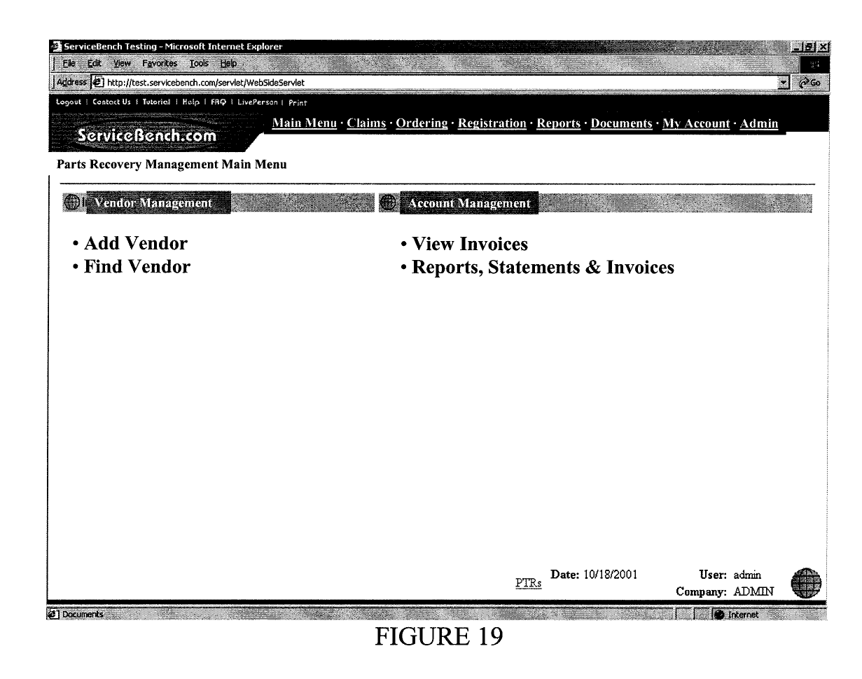

FIG. 19 shows an example screen of the various options that will be available for managing this process. This screen is reached from a Parts Recovery link on the Admin page. This link can be found under the current Analysis section.

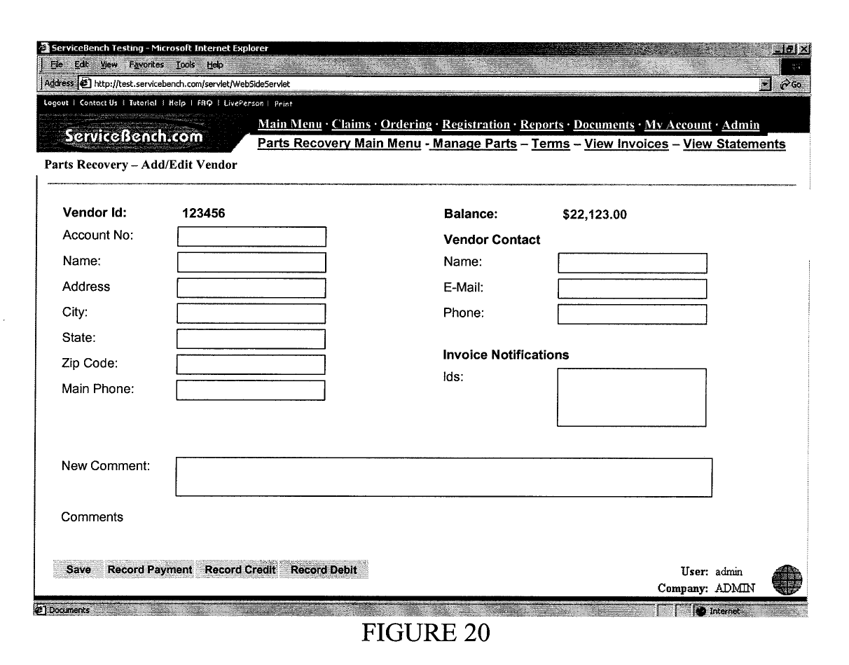

FIG. 20 shows an example screen for allowing the manufacturer to add a Vendor (supplier) who is to be invoiced and to identify parts associated with that vendor. The figure shows the screen for management of this information.

Invoice Notifications is list of System users for the manufacturer who are notified via e-mail when the invoice is generated so user can have a summary of the invoice information. Comments can identify who made them and work as they do in the current claims processing. The links at the top of this page include:
Parts Recovery Main Menu—Brings back up the Parts Recovery Main Menu.
Manage Parts—Brings up the Manage Parts page for this Vendor.
Terms—Brings up the Terms page for this Vendor.
View Invoices—Brings up the View Invoices page.
View Statements—Brings up the View Statements page.

The buttons at the bottom of this page include:
Save—Saves the changes made to the form.
Record Payment—Brings up the Record Credit page.
Record Credit—Brings up the Record Credit page.
Record Debit—Brings up the Record Credit page.

Manage Parts: The Manage Parts function allows the user to identify the parts associated with this vendor. This screen will display a list of parts that have been associated with this vendor. The parts can be listed in Part Number Order, for example. The parts can be displayed in a table with the following columns:
Delete—The trashcan icon. When pressed the user will be prompted to see if they really want to delete the part. If so, the part is removed from the vendor's list;
Part Number;
Part Description;
Part Price—Price Paid by the Manufacturer for the Part.

At the top of this screen is a field in which a part number can be entered. Next to this field is a button called Add. When clicked, the associated part is added to the list for this vendor.

The links at the top of this page include:
Parts Recovery Main Menu—Brings back up the Parts Recovery Main Menu.
Terms—Brings up the Terms page for this Vendor.
Edit—Brings up the Edit page for this Vendor.
View Invoices—Brings up the View Invoices page.
View Statements—Brings up the View Statements page.

Terms: A Terms page can be provided to allow the user to specify how the invoice is generated for this vendor. The user is allowed the following control fields (these are per vendor):

TABLE 2

| Field Name | Format | Validations |
|---|---|---|
| Invoice | Pull-down selection | This field must be specified |
| Control | with the choices: | although that can be |
| | Standard, No Fee, | controlled by only allowing 3 |
| | and No Invoice. | choices. The default should |
| | | be Standard. |
| Part % | Number | Must be from 0-100. |
| Labor % | Number | Must be from 0-100. |
| Total % | Number | Must be from 0-100. If |
| | | Total % has a value > 0, then |
| | | a value cannot be entered for |
| | | Part % and/or Labor $ %. |
| Starting Balance | Number | Dollar Value. |

All fields should typically default to 0. Note: The usage of these fields is described in the sections View Invoices and View Statements below. The following button is available on this screen:
Save—Saves the updated values for the form.

The links at the top of this page include:
Parts Recovery Main Menu—Brings back up the Parts Recovery Main Menu.
Manage Parts—Brings up the Manage Parts page for this Vendor.
Edit—Brings up the Edit page for this Vendor.
View Invoices—Brings up the View Payments page.
View Statements—Brings up the View Statements page.

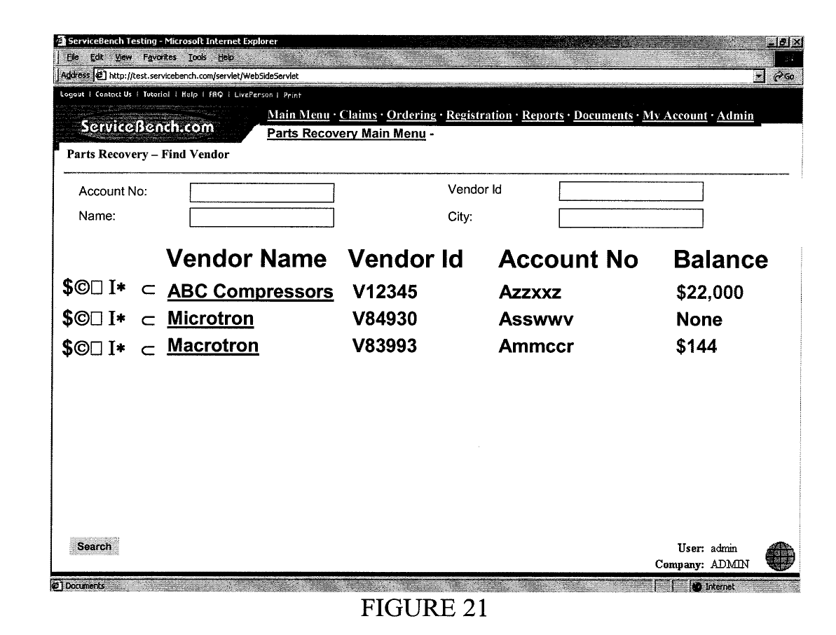

FIG. 21 shows a screen providing the ability to allow the manufacturer to find existing vendors and to manage them. The icon links on this page include:
Edit Vendor—Brings up the Edit Vendor page.
Invoices—Brings up the View Payments page.
Statements—Brings up the View Statements page.
Record Payment—Brings up the Record Credit page.
Record Credit—Brings up the Record Credit page.
Record Debit—Brings up the Record Credit page.

The links at the top of this page include:
Parts Recovery Main Menu—Brings back up the Parts Recovery Main Menu.

The buttons at the bottom of this page include:
Search—Reinitiates the search based upon the specified criteria.

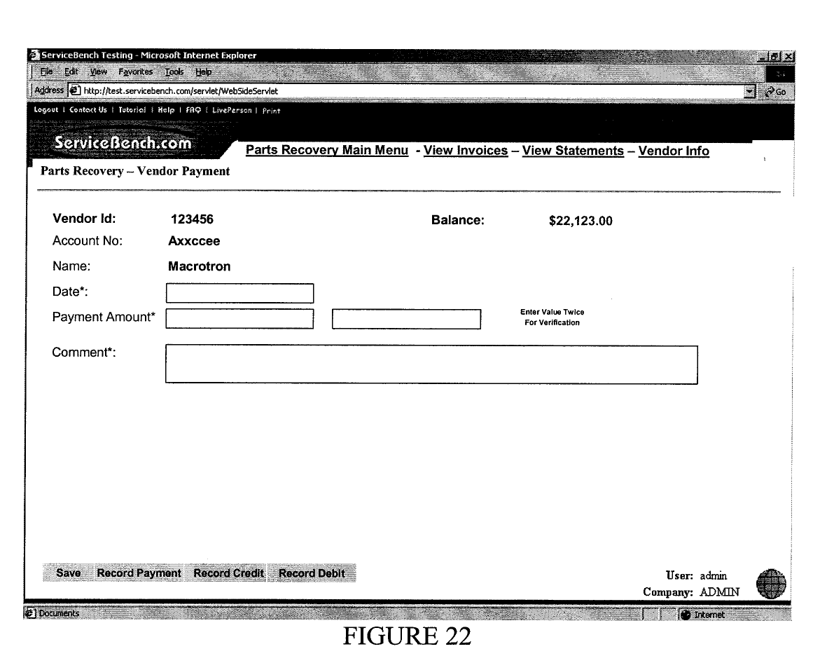

Record Payment: The Record Payment screen is shown in FIG. 22. The Balance shown at the top of the page is the current balance for that vendor. The links at the top of this page include:
Parts Recovery Main Menu—Brings back up the Parts Recovery Main Menu.
View Invoices—Brings up the View Payments page.
View Statements—Brings up the View Statements page.
Vendor Info—Brings up the Add & Edit Vendor page.

The buttons at the bottom of this page include:
Save—Saves the changes made to the form. The form is redisplayed indicating that the save was successful. The user will not be able to edit the record at that point.
Record Payment—Brings up the Record Credit page.
Record Credit—Brings up the Record Credit page.
Record Debit—Brings up the Record Credit page.

When a previously created credit is displayed at the bottom of the form, it should identify who created the record and when it was created. For accounting and control purposes, records cannot be edited once they have been saved but may only be changed by making opposite corresponding entries.

Record Credit: This screen is the same as the payment screen except Payment Amount is called Credit Amount.

Record Debit: This screen is the same as the payment screen except Payment Amount is called Debit Amount.

View Invoices: Like the dealer payments section in claims, this link brings up a list of Invoices, which can be viewed individually. Invoices are not generated for Vendors whose Invoice Control is set as “No Invoice”. Invoices are generated as follows:

On a periodic basis, a job is run that gathers information by vendor for 1st year warranty claims that have been approved in the last cycle. This job generates a single row for each part that has been identified for that Vendor. Within that row are the following columns are presented.

TABLE 3

| Column | Comes From |
|---|---|
| Part Number | The Number of the Part |
| Part Description | The Description of the Part. |
| Quantity | The total number of these parts that |
| | have been accumulated from the claims. |
| Failure Rate | For parts that have Units in Production, |
| | this percentage is calculated by taking |
| | the Quantity and dividing it by the |
| | Units in Production. |
| Part Cost | Add up the total value cost of the parts |
| | (from the STK1 price) plus 15% of the |
| | distributor price. Take this value and |
| | multiply it by the Part % from the Terms. |
| Labor Cost | Take the labor cost from any claim |
| | containing this part and multiply it |
| | by the Labor % from the Terms. |
| Total Cost | If the Total Cost % from the Terms is |
| | 0, then add the Part Cost and Labor Cost |
| | to compute this value. If the Total Cost |
| | % is not zero, take the total cost from |
| | any claim containing this part and |
| | multiply it by the Total Cost %. |

If the Vendor's Invoice Control is set to Standard, under the last row should be a sum of the Total Cost, which is the Invoice total. If the Vendor's Invoice Control is set to No Fee, then this Invoice Total (and the amount recorded) should be set to $0.00.

View Statements: This link brings up the current statement for the vendor. The default for this should be 3 months (the current month plus the previous 2). This screen has an option to show the statement for user entered time period. Data on the system can be time limited (e.g., two years).

Statements are simply a listing of the current account for the vendor. It is started by an initial row showing the balance of the account at the beginning of the specified period. Subsequent rows show the various transactions (in time order) that have appeared within the period and the current running balance.

Statements should be viewed from the perspective of the vendor. Therefore, Invoices and Debits will be added to the total and Credits and Payments will be subtracted. Statements will be viewed in a table format with the following columns as an example:

TABLE 4

| Column | Description |
|---|---|
| Vendor | Identifies the Vendor. This column |
| | should only be displayed for the |
| | first row of data for that vendor. |
| | The first row will always be the |
| | Balance Fwd row. It will not have |
| | values in either the Debit or Credit |
| | Amount Columns. Its date should be |
| | the initial date of the report. |
| Eye Icon | This function allows the user to |
| | view the individual amount |
| Date | Date of the Item |
| Transaction | What the item is and Identifying |
| | number. Item types are: Balance |
| | Fwd, Invoices, Credits, Payments |
| | and Debits. |
| Debit Amt | Amount for Debit Items |
| Credit Amt | Amount for Credit Items |
| Balance | The running balance. Generally |
| | this is the balance of the line |
| | above plus the Debit Amt and minus |
| | the Credit Amt. |

Reports, Invoices and Statements: The following reports can be generated by the system for use by manufacturer personnel:
Vendor Summary Report: Gives a summary of the all vendors. This is in a table format with one line per vendor. Each line will indicate the vendor's account number, name, date of last payment and current balance. An option should be to suppress Vendors with a balance of zero.
Vendor Trending Report: This report generates for a specified period the amount invoiced to each vendor. This report could be optimized for Excel, for example. The report could list vendor, date and amount invoiced. The user can optionally select a vendor.
Top 150 Parts Recovery Reports—This existing report needs the following changes or validations:
   Needs to Support 150 Parts (Already Complete)
   Needs to Identify the Vendor if one has been assigned.
   Needs to support only displaying parts that have not been assigned. (This can be handled through a separate report if desired).
Invoices—The user can generate invoices in a print ready format for a particular run. The user can optionally select a vendor.
Statements—The user can generate statements in a print ready format for a particular time range. The user can optionally select a vendor.

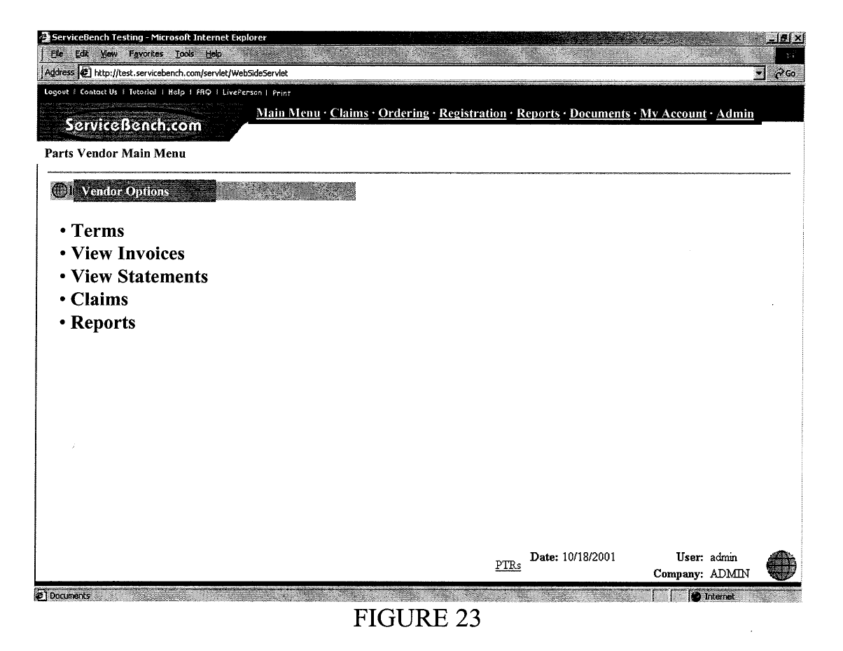

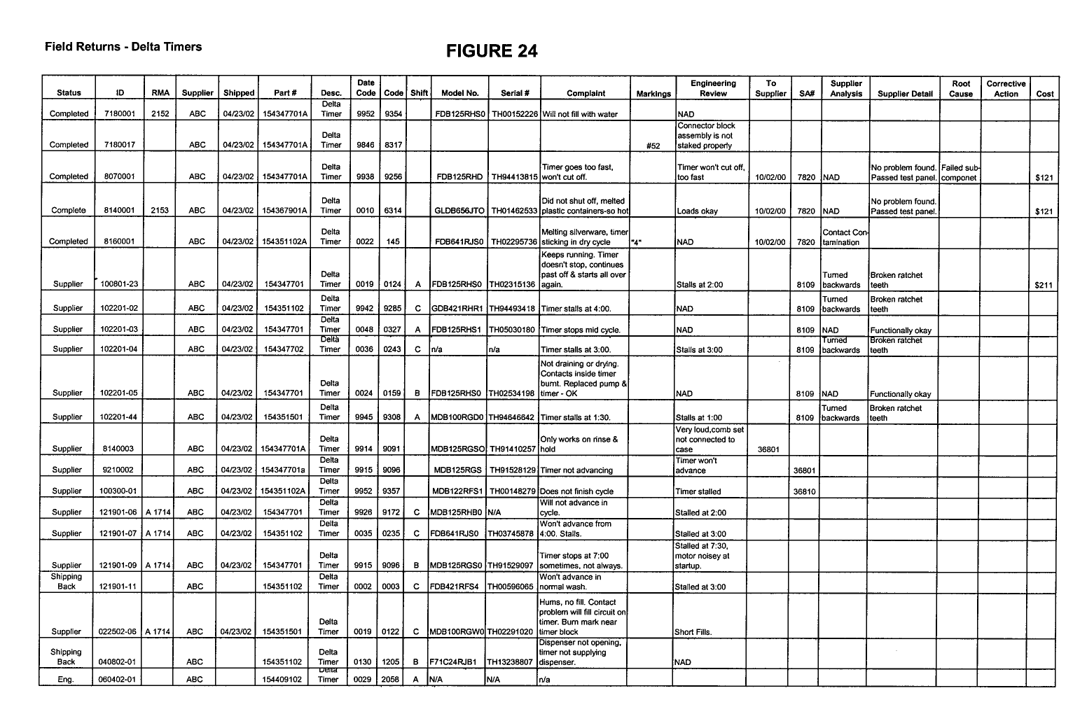

Parts Vendor Functionality: Manufacturer Parts Vendors can receive access to the System. From their accounts they will be able to access a Parts Vendor Main Menu. The Parts Vendor Main Menu can look as shown in FIG. 23, and have the following links:
Terms—A read-only version of the Terms page.
View Invoices—Provides the same functionality as the manufacturer View Invoices function. Edits may be prevented.
View Statements—Provides the same functionality as the manufacturer View Invoices function. Edits may be prevented. Included on the statement can be YTD Charges, Debts, Payments, Credits, and Balance.
Claims—Brings up a search screen that the Vendor can use to find claims. Hard coded in the search will be a limitation to only see claims that are included in the invoices and contain a part produced by that vendor. Other search fields include:
   Part Number
   Model Number
   Invoice Date (Month and Year)—Searches are limited to a particular Invoice for performance reasons.

When the claims is displayed, the vendor can be able to see the following fields:
His Parts—Part Number and Quantity but No Prices
Model Number
Fault Code
Customer Complaint
Explanation of Service
Claim Date
Claim Number

Reports—The following reports can be included:
A summary report showing claim details for each invoice.
Invoices—The user can generate invoices in a print ready format for a particular run.
Statements—The user can generate statements in a print ready format for a particular time range.

Claim Listing—A list of claim information (what is visible above) for selected claims. Criteria for selection will be:
Date Range
Model Number
Part Number

Parts In Use Data: On a periodic basis (generally once per month), the manufacturer will send a loadable file, such as a CSV file, to the system via a standard FTP procedure that contains a count of the number of parts in production for each individual part. The file will have the following fields per row (one row per part). The file will only contain a subset of the actual total parts:
Part Number
Units In Production

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A method for quality improvement and cost recovery using a tracking system, said method comprising the steps of:
determining which components failed in a plurality of a particular product;
said system automatically calculating recovery costs for the failed components;
said system automatically determining which among a plurality of suppliers provided said failed components;
said system automatically allocating said recovery costs among the plurality of suppliers according to which suppliers provided said failed components;
said system automatically generating quality information for the plurality of suppliers which provided said failed components; and
said system automatically providing an appropriate portion of said quality information to one or more of the plurality of suppliers which provided said failed components.

2. The method of claim 1, wherein said automatically providing is accomplished utilizing a web server to serve said appropriate portion of said quality information, via a computer network, to a computer workstation executing a viewing application.

3. The method of claim 2, further comprising the step of invoicing appropriate ones of said suppliers to recover said recovery costs.

4. The method of claim 3, further comprising the step of said system automatically sending the invoices to said suppliers via the Internet.

5. The method of claim 4, wherein said appropriate portion of said quality information is accessed by said one or more of the plurality of suppliers via one or more computers connected to the Internet.

6. The method of claim 3, wherein said step of automatically sending invoices is executed periodically.

7. The method of claim 3, wherein the invoice amount is a function of failed component costs and labor repair charges associated with specific warranty claims.

8. The method of claim 3, wherein said appropriate portion of said quality information is accessed by said one or more of the plurality of suppliers via the Internet.

9. The method of claim 1, wherein appropriate ones of said suppliers are invoiced to recover said recovery costs.

10. The method of claim 1, wherein said appropriate portion of said quality information is accessed by said one or more of the plurality of suppliers via one or more computers connected to the Internet.

11. The method of claim 1, further comprising the step of providing a sample of at least one of the failed components to the appropriate supplier when the failed components of the appropriate supplier fail at a higher than expected rate.

12. The method of claim 11, further comprising the steps of:
calculating a statistically appropriate sample size of the failed components, and
providing a report identifying a specific number of the failed components that should be shipped to said appropriate supplier.

13. The method of claim 11, further comprising the steps of:
calculating a statistically appropriate sample size of the failed components to identifying a specific number of the failed components that should be shipped to said appropriate supplier; and
shipping said specific number of failed components to the appropriate supplier.

14. The method of claim 13, wherein said failed components are tracked by the appropriate supplier using said system.

15. The method of claim 13, wherein said appropriate supplier uses said system to enter failure information regarding the failure of said failed components, and wherein said quality information is generated using said failure information.

16. The method of claim 15, wherein said system is used to automatically generate an address label for shipping said failed components.

17. The method of claim 11, wherein at least one of the failed components is tracked by the appropriate supplier using said system via a computer connected to the Internet.

18. The method of claim 17, wherein said appropriate supplier uses said system to enter failure information regarding the failure of said at least one of the failed components via the computer connected to the Internet, and wherein said quality information is generated using said failure information.

19. A method for quality improvement and cost recovery using a tracking system including a database, said method comprising the steps of:
providing a plurality of components, each of said components being associated, in the database, with a supplier who produced the component;
providing a plurality of products each including at least one of said components;
determining which of said components failed during a warranty period of each of said products;
creating a record of each of said failed components in the database;
collecting some number of said components that failed for analyzing said some number of failed components;
creating a record of each of said some number of failed components in the database;
determining corresponding failure information for each of said some number of failed components;
associating, in the database, the record of each of said some number of failed components with the corresponding failure information;
said system automatically calculating a recovery cost for each of the suppliers based on the total number of failed components provided by said each of the suppliers;
storing said recovery costs in the database;
said system automatically generating an electronic invoice based on the recovery cost for each of said suppliers;
said system automatically generating a quality report for each of said suppliers, said quality report including information about the failed components provided by the supplier and also including information about the associated failure information;
said system automatically providing each of said invoices to the appropriate one of said suppliers; and
said system automatically providing each of said quality reports to the appropriate one of said suppliers.

20. A method for quality improvement and cost recovery using a tracking system connected to the Internet, said system including a database and a server, said method comprising the steps of:
providing a plurality of a product, said product including at least one of a plurality of components provided by a supplier;
entering a record of each of the components in the database;
associating, in the database, the supplier with the component records;
determining which of said components failed in the plurality of products during a warranty period of each of the products;
creating a record of each of the failed components in the database;
calculating a statistically appropriate sample size of the failed components when the failed components fail at a higher than expected rate during the warranty periods;
shipping a specific number, based on said sample size, of the failed components to the supplier;
creating a record of each of the shipped components in the database;
tracking the shipped components using said system;
the supplier analyzing the shipped components to determine failure information about each of the shipped components;
said supplier using said system to enter, via the internet, the failure information into the database;
associating, in the database, the record of the shipped components with the corresponding failure information;
said system automatically calculating a recovery cost for the supplier based on at least all of a total number of the number of failed components, the cost of the failed components, and a labor cost of repairing the products including failed components;
storing said recovery cost in the database;
said system automatically generating an electronic invoice, based on said recovery cost, for the supplier;
said server automatically sending, via a communication network, said electronic invoice to the supplier;
said system automatically generating a quality report for the supplier, said report utilizing said failure information and at least some of said records stored in said database; and
said system server automatically providing the supplier secure access to said quality report via a computer connected to the communication network.
